(19) United States
(12) Patent Application Publication
(10) Pub. No.: US 2008/0136928 A1
(43) Pub. Date: Jun. 12, 2008

(54) METHOD OF ACCELERATING AN IMAGE CAPTURING PROCESS AND RELATED DIGITAL IMAGE CAPTURING DEVICE

(76) Inventor: Chun-Chang Wang, Hsinchu City (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 11/684,456

(22) Filed: Mar. 9, 2007

(30) Foreign Application Priority Data
Dec. 8, 2006 (TW) 095146176

(51) Int. Cl. H04N 5/228

(52) U.S. Cl. 348/222.1; 348/E05.099

(57) ABSTRACT

A method of accelerating an image capturing process is disclosed. The method is used to a digital image capturing device. The image capturing process comprises a sub-period and an exposure period. The method comprises the steps of: executing the image capturing process for a frame; receiving an instant control signal; ending the sub-period if receiving the instant control signal during the sub-period; ending the exposure period if receiving the instant control signal during the exposure period; and executing a new exposure period for the frame.

### BACKGROUND OF THE INVENTION

1. Field of the Invention

The present invention relates to a method of accelerating an image capturing process, and more particularly, to a method of accelerating an image capturing process having a fast exposure period.

2. Description of the Related Art

In today's technology, digital image capturing devices are extremely popular devices, and users are demanding increasingly better performance from digital image capturing devices. In the prior art technology, if a user wants to use the digital image capturing device, the digital image capturing module cannot immediately execute an exposure procedure. When the operation desired by the user is triggered during a frame exposure period, the digital image capturing module must wait for the next frame to begin a valid exposure period. Consequently, the digital image capturing module must wait for the period of time required to process one frame before executing a new operation command. As a result, the digital image capturing device requires a relatively longer processing time, which may effect the processing time for auto exposure or auto white balance.

Therefore, it is desirable to provide a method of accelerating the image capturing process and a related digital image capturing device to mitigate and/or obviate the aforementioned problems.

### SUMMARY OF THE INVENTION

A main objective of the present invention is to provide a method of accelerating an image capturing process for a digital image capturing device.

In order to achieve the above-mentioned objective, the digital image capturing device comprises a processor, a timing generator, and a digital image capturing module. The processor is used for processing the various procedures of the digital image capturing device. The digital image capturing module comprises a plurality of photo diodes for performing an exposure procedure. The timing generator is used for controlling an image capturing procedure of the digital image capturing module.

The method of accelerating an image capturing process of the present invention comprise: the digital image capturing device executes the image capturing procedure. If the timing generator receives the instant control signal, the timing generator checks which procedure is performed by the image capturing procedure; if the sub-period is performed, the timing generator ends the sub-period to enter a new exposure period.

If the exposure period is performed, the timing generator ends the exposure period and executes the new sub-period to clear the exposed photo diodes. After the exposed photo diodes are cleared, the timing generator ends the new sub-period.

After the new sub-period is ended, the timing generator executes the new exposure period. The present invention can increase the image capturing speed of the digital image capturing device without wasting the time associated with another frame.

Other objects, advantages, and novel features of the invention will become more apparent from the following detailed description when taken in conjunction with the accompanying drawings.

### BRIEF DESCRIPTION OF THE DRAWINGS

FIG. 1 is a hardware structural drawing of a digital image capturing device according to the present invention.

FIG. 2 illustrates the digital image capturing device executing an image capturing procedure according to the present invention.

FIG. 3 is a flow chart for an image capturing procedure performed by the digital image capturing device according to the present invention.

FIGS. 4A-4D show the digital image capturing device performing an image capturing procedure according to the present invention.

### DETAILED DESCRIPTION OF THE PREFERRED EMBODIMENT

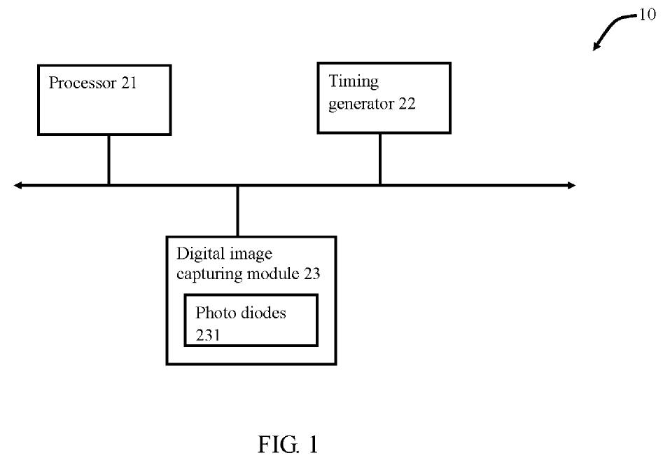

Please refer to FIG. 1. FIG. 1 is a hardware structural drawing of a digital image capturing device according to the present invention. The digital image capturing device 10 may be a digital camera, a digital video camera or another equivalent device. The digital image capturing device 10 comprises a processor 21, a timing generator 22, and a digital image capturing module 23. All elements are electrically connected to each other. The processor 21 is used for processing the various procedures of the digital image capturing device 10. The digital image capturing module 23 may include CCD elements or CMOS elements for capturing images; in this embodiment, CCD elements are utilized. The digital image capturing module 23 comprises a plurality of photo diodes 231 for performing an exposure procedure.

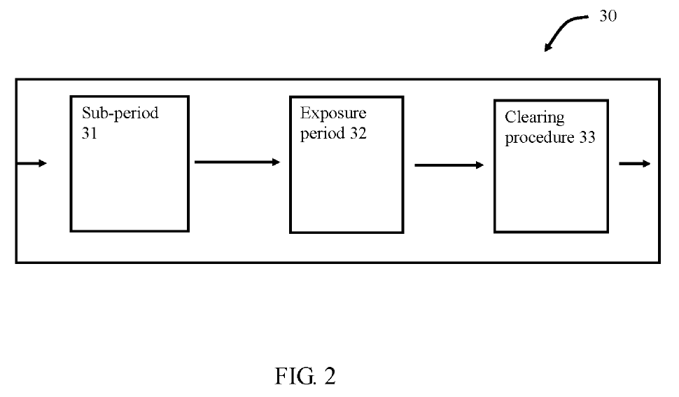

The timing generator 22 is used for controlling an image capturing procedure 30 of the digital image capturing module 23. Please refer to FIG. 2. FIG. 2 illustrates the digital image capturing device executing an image capturing procedure according to the present invention. In general, the image capturing procedure 30 of the digital image capturing module 23 comprises a sub-period 31, an exposure period 32, and a clearing procedure 33, with each period controlled by the timing generator 22.

The sub-period 31 is used for transferring exposure charge in the photo diodes 231 or for an automatic focusing process during a non-exposure period of the digital image capturing module 23. The exposure period 32 is used for performing an exposure process with the photo diodes 231. The clearing procedure 33 clears any remaining unperformed procedure in the current frame before the next frame is begun. The image capturing procedure 30 may also include other procedures; however, this is not a primary characteristic of the present invention, and so requires no further discussion.

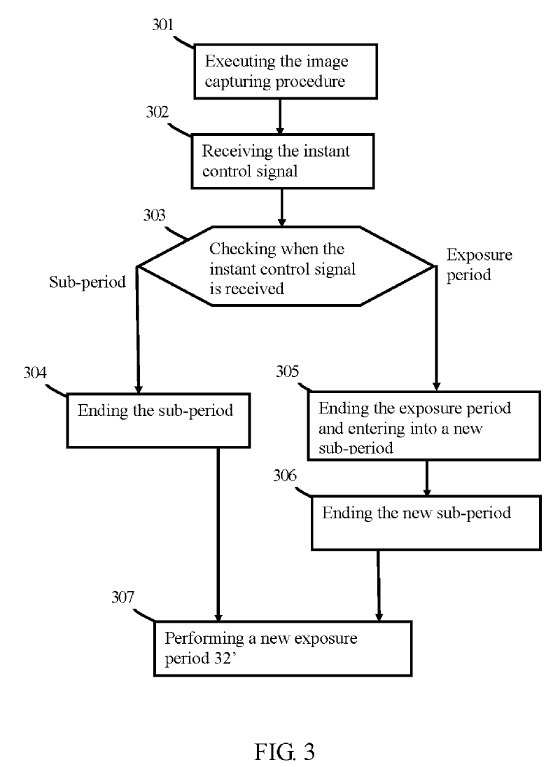

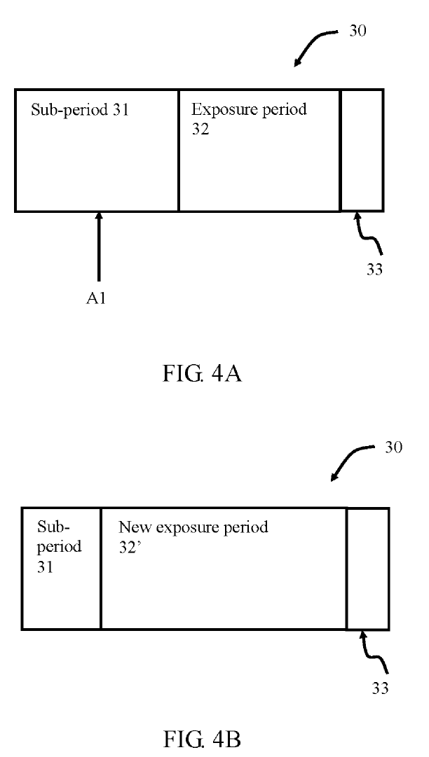

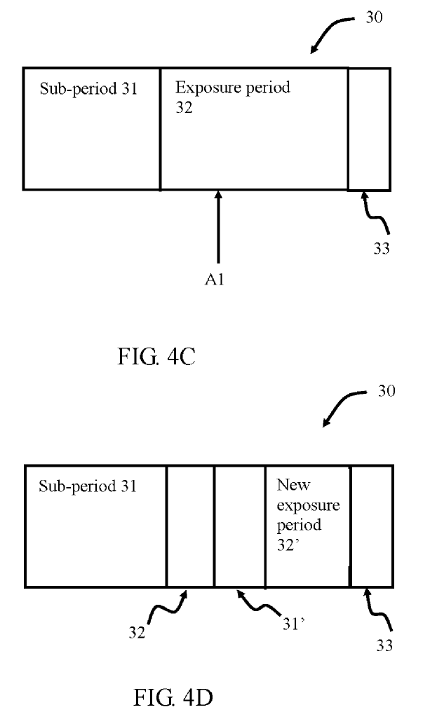

Please refer to FIG. 3 and FIGS. 4A˜4D. FIG. 3 is a flow chart for the image capturing procedure performed by the digital image capturing device according to the present invention. FIGS. 4A˜4D show the digital image capturing device performing the image capturing procedure according to the present invention.

The digital image capturing device 10 executes step 301: executing the image capturing procedure 30.

At the start of the processing procedure of one frame, the digital image capturing device 10 begins with the first period of the image capturing procedure 30, which is a charge transfer phase. Then, the sub-period 31 or the exposure period 32 is performed.

Next, in step 302: receiving the instant control signal A1.

If the user wants to use the digital image capturing device 1 0 to take a picture or use other functionalities, he or she can press an operating button to send out an instant control signal A1. The timing generator 22 receives the instant control signal A1 to execute step 303.

Step 303: checking when the instant control signal A1 is received.

The timing generator 22 first checks whether the digital image capturing module 23 is performing the sub-period 31 or the exposure period 32 of the image capturing procedure 30.

If the image capturing procedure 30 is performing the sub-period 31 (as shown in FIG. 4A), step 304 will be performed immediately.

Step 304: ending the sub-period 31.

The timing generator 22 immediately gives a command to end the sub-period 31 to enter into the next procedure. Next, step 307 is performed (as shown in FIG. 4B).

As shown in FIG. 4C, the instant control signal A1 is received when exposure period 32 of the image capturing procedure 30 is being performed, and step 305 is performed to end the exposure period 32 and enter into a new sub-period 31′.

As shown in FIG. 4D, the timing generator 22 immediately ends the exposure period 32 and executes a new sub-period 31′. The new sub-period 31′ has the same purpose as the sub-period 31. Therefore, the exposure charge within the photo diodes 231 in the digital image capturing module 23 can be cleared.

Nest, in step 306: ending the new sub-period 31′.

After clearing the exposure charge within the photo diodes 231, the timing generator 22 ends the new sub-period 31′.

Finally, step 307 is executed to perform a new exposure period 32′.

After the sub-period 31 (step 304) or the new sub-period 31 ′ (step 306) has ended, the timing generator 22 immediately controls the digital image capturing module 23 to enter into the new exposure period 32′. The new exposure period 32′ has the same purpose as the exposure period 32. The digital image capturing device 10 is then able to execute the process requested by the instant control signal that had been activated by the user.

The clearing procedure 33 may be preformed to clear any remaining unperformed procedure in the current frame before the next frame is begun.

The method of the present invention thus enables the instant control signal A1 activated by the user to finish its related processing procedure in one frame. Moreover, the present invention can increase the image capturing speed of the digital image capturing device 10 without wasting the time associated with another frame.

Although the present invention has been explained in relation to its preferred embodiment, it is to be understood that many other possible modifications and variations can be made without departing from the spirit and scope of the invention as hereinafter claimed.

What is claimed is:

1. A method of accelerating an image capturing process for a digital image capturing device to execute the image capturing process for a frame, the image capturing process comprising a sub-period and an exposure period, the method comprising:
executing the image capturing process for the frame;
receiving an instant control signal; and
executing a new exposure period for the frame.

2. The method of accelerating an image capturing process as claimed in claim 1 further comprising: checking whether the instant control signal is received during the sub-period, and if it is, ending the sub-period.

3. The method of accelerating an image capturing process as claimed in claim 1 further comprising: checking whether the instant control signal is received during the exposure period, and if it is, ending the exposure period.

4. The method of accelerating an image capturing process as claimed in claim 3 further comprising: performing a new sub-period.

5. The method of accelerating an image capturing process as claimed in claim 1 further comprising: executing a clearing procedure.

6. A digital image capturing device with an accelerated image capturing processing capability, the digital image capturing device comprising:
a processor;
a digital image capturing module electrically connected to the processor; and
a timing generator electrically connected to the digital image capturing module and used for controlling the digital image capturing module to execute an image capturing process in a frame, the image capturing process comprising a sub-period and an exposure period; the
processor controlling the timing generator and the digital image capturing module to achieve the following means:
executing the image capturing process of the frame;
receiving an instant control signal; and
executing a new exposure period of the frame.

7. The digital image capturing device as claimed in claim 6, wherein the timing generator is used for checking whether the instant control signal is received during the sub-period, and if it is, ending the sub-period.

8. The digital image capturing device as claimed in claim 6, wherein the timing generator is used for checking whether the instant control signal is received during the exposure period, and if it is, ending the exposure period.

9. The digital image capturing device as claimed in claim 8, wherein the timing generator is further used for performing a new sub-period.

10. The digital image capturing device as claimed in claim 6, wherein the timing generator is further used for executing a clearing procedure.

11. The digital image capturing device as claimed in claim 6, wherein the digital image capturing device further comprises a plurality of photo diodes.

12. The digital image capturing device as claimed in claim 6, wherein the digital image capturing device is a digital camera or a digital video camera.
